(19) United States
(12) Patent Application Publication
(10) Pub. No.: US 2003/0199410 A1
(43) Pub. Date: Oct. 23, 2003

(54) Water removal from a surface without use of a hydrocarbon

(75) Inventors: Michael E. Besse, Golden Valley, MN (US); Jeffy D. Hoyt, Hastings, MN (US); Terry J. Klos, Victoria, MN (US); Robert D.P. Hei, Baldwin, WI (US)

Correspondence Address: Merchant & Gould P.C., P.O. Box 2903, Minneapolis, MN, 55402-0903, US

(73) Assignee: Ecolab Inc.

(21) Appl. No.: 10/121,175

(22) Filed: Apr. 11, 2002

(51) Int. Cl. C23G 1/02; B08B 3/00; C11D 1/00

(52) U.S. Cl. 510/189; 134/3; 134/26; 134/28; 134/36; 510/499

(57) ABSTRACT

The present invention is directed to compositions that include:

(a) about 0.1 to about 55 wt-% of an alkyl ether amine composition of the formula (Ia):

^{R}^{₁}^{—O—R}^{₂}^{—NH—A} (Ia)

wherein A is hydrogen or R₃NH₂, R is a C₆-C₂₈ fatty aliphatic group, and R₂ and R₃ are each independently a C₁-C₈ alkylene; an alkyl diamine compound of formula (Ib):

RNCH₂CH₂CH₂NH₂ (Ib)

wherein R is C₆-C₂₀ alkyl; or a mixture thereof

(b) about 0.1 to about 55 wt-% of propoxylated or mixed alkoxylated quaternary ammonium compound of the formula (II)

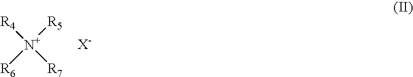

wherein R₄, R₅, R₆, and R₇ are each independently hydrogen, C₁-C₁₀ alkyl, or C₁-C₁₀ alkoxy, such that at least two of R₄, R₅, R₆, and R₇ are a C₁-C₁₀ alkyl, or at least one of R₄, R₅, R₆, and R₇ are a C₁-C₁₀ alkoxy; and X includes an anion;

(c) a stabilizer including a neutralizing acid and a nonionic surfactant; and

(d) water.

The present invention is also directed to methods of drying and polishing a vehicle surface by using the vehicle care composition.

### FIELD OF THE INVENTION

The invention relates to cleaning compositions and methods for cleaning vehicle surfaces. In particular, the invention relates to vehicle care compositions that do not depend upon hydrocarbons and that are useful for drying and/or polishing the surface of a vehicle, and to methods for their use.

### BACKGROUND OF THE INVENTION

Vehicle care compositions can serve a variety of purposes, such as cleaning, drying and polishing the surface of a vehicle. In fact, several different cleaning compositions may be employed during one vehicle cleaning cycle. For example, in automatic and semi-automatic car washes, different cleaning compositions are generally used in the pre-rinse or pre-cleaning step, which is then followed by a combination of one or more steps using waxes, rinses, and anti-rust agents, each of which may have a different cleaning composition.

Drying agents and polishes containing a hydrocarbon, applied after the cleaning step, promote a shiny finish and are blended to promote removal of water from vehicle surfaces. Such products also often contain a cationic and/or nonionic surfactants, hydrocarbon, and other components that form a fully functional system that can help dewater automobiles leaving a dry shiny finish.

Amine compounds have also been formulated in hydrocarbon containing and silicone containing wax compositions and compositions that contain both hydrocarbons and silicones. However, drying and polish compositions that contain hydrocarbons may leave a residue on a vehicle surface. Moreover, hydrocarbon compounds can be environmentally unfriendly. Therefore, a need exists for drying and polish compositions that do not contain hydrocarbons.

### SUMMARY OF THE INVENTION

The present invention relates to cleaning compositions and methods for cleaning vehicle surfaces. In particular, the invention relates to vehicle care compositions that do not depend upon hydrocarbons and that are useful for drying and/or polishing the surface of a vehicle, and to methods for their use. The vehicle care compositions include alkyl ether amine, alkyl diamine, or combination thereof; propoxylated or mixed alkoxylated quaternary ammonium compound; and stabilizer. Preferably, the compositions lack hydrocarbons, such as mineral seal oil, typically employed in vehicle care compositions for drying or polishing.

The present vehicle care compositions include:

(a) about 0.1 to about 55 wt-% of an alkyl ether amine of formula (Ia):

^{R}^{₁}^{—O—R}^{₂}^{—NH—A} (Ia)

wherein A is hydrogen or R₃NH₂, R is a C₆-C₂₈ fatty aliphatic group, and R₂ and R₃ are each independently a C₁-C₆ alkylene; of an alkyl diamine of formula (Ib):

RNCH₂CH₂CH₂NH₂ (Ib)

wherein R is C₆-C₂₀ alkyl; or of a mixture thereof;

(b) about 0.1 to about 50 wt-% of a propoxylated or mixed alkoxylated quaternary ammonium compound of the formula (II):

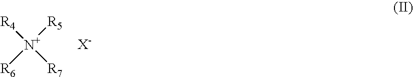

wherein R₄, R₅, R₆, and R₇ are each independently hydrogen, C₁-C₁₀ alkyl, C₁-C₁₀ alkoxy, or phenyl, such that at least two of R₄, R₅, R₆, and R₇ are a C₁-C₁₀ alkyl, or at least one of R₄, R₅, R₆, and R₇ are a C₁-C₁₀ alkoxy; and X includes an anion; and

(c) stabilizer including neutralizing acid and/or nonionic surfactant. The compositions can also contain water.

In an embodiment, the present invention includes a method of drying a vehicle surface by applying to a substantially clean vehicle surface a drying composition containing the above-described vehicle care composition and draining or blowing a solution of the composition from the vehicle surface.

In an embodiment, the present invention includes a method of polishing a vehicle surface by applying to a vehicle surface a polishing composition containing the vehicle care composition, subjecting the vehicle surface and the polishing composition to a mechanical action, and removing the polishing composition from the vehicle surface.

### DETAILED DESCRIPTION OF THE INVENTION

The present vehicle care compositions are effective for vehicle care purposes, such as drying or polishing, without depending on hydrocarbons conventionally incorporated in such compositions used for, for example, polishing or drying. For example, the present vehicle care compositions do not depend upon hydrocarbons or petroleum distillates, such as mineral seal oil, for their function as drying or polishing compositions. Preferably, the present vehicle care compositions do not include hydrocarbons or petroleum distillates. The present vehicle care compositions include alkyl ether amine, alkyl diamine, or combination thereof; propoxylated or mixed alkoxylated quaternary ammonium compound; and stabilizer.

Definitions

Reference in the specification and claims to parts by weight of a particular element or component in a composition denotes the weight relationship between the element or component and any other elements or components in the composition or article for which a part by weight is expressed.

As used herein, the term “hydrocarbon free” means that the materials of the invention do not contain a substantial proportion of any hydrocarbon that can participate in either soil removal, dewatering or providing a polish to a vehicle surface. “Vehicles” as used herein includes those vehicles commonly washed in commercial vehicle washing facilities including, automobiles, trucks, and sport utility vehicles, as well as other transportation devices, such as airplanes, jet aircraft, helicopters, buses, golf carts, motorcycles, monorails, locomotives, and boats. Vehicle surfaces to be cleaned include, but are not limited to, painted surfaces, thermal plastic composite surfaces, glass surfaces, rubber surfaces, fiberglass surfaces, or metal surfaces. The structure of the surface to be cleaned can vary widely and is unlimited.

As used herein, the phrase “substantially neutral” refers to a pH from about 5 to about 9, preferably from about 6 to about 8, preferably from about 6.5 to about 7.5.

As used herein, the phrase “slightly acidic pH” refers to a pH from about 6.9 to about 3.5, preferably from about 6.5 to about 4.5, preferably from about 6.5 to about 5.5.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to aging of a composition with a particular initial mixture. Whether or not modified by the term “about”, the claims include equivalents to the quantities.

As used herein, the term “consisting essentially of” refers to a vehicle care composition that includes the ingredients listed in the claim, plus other ingredients that do not materially affect the basic and novel properties of the vehicle care composition, but that lack hydrocarbons conventionally incorporated in vehicle care compositions used for, for example, polishing or drying. Such hydrocarbons include petroleum distillates, such as mineral seal oil, kerosene, aliphatic hydrocarbons, and the like. Ingredients that materially affect the basic and novel properties of the vehicle care composition impart undesirable characteristics including the environmental drawbacks of petroleum distillates and other hydrocarbons; the undesirable toxicity of petroleum distillates and other hydrocarbons; the undesirable skin, eye, and lung irritation caused in some people or at some doses by exposure to petroleum distillates and other hydrocarbons; leaving petroleum distillate or hydrocarbon residue on the article cleaned, rinsed, or polished.

Vehicle Care Compositions

The ether amine and diamine compositions of the invention are typically used in drying compositions and polishing compositions. Such compositions can be formulated as foam, liquid or solid concentrate materials in which the composition can be diluted with service water to form a material that can be readily applied (i.e.) sprayed onto a vehicle surface for the purpose of cleaning the vehicle surface. In general, when the concentration of the composition in the solution is above about 25 wt-%, the solution is considered to be a concentrated solution; and when the concentration of the composition in the solution is below about 25 wt-%, the solution is considered to be a use solution.

General areas of use for these materials and processes include, but are not intended to be literally limited to presoak washes, preliminary washes, substantive washes, post washes, and rinses used in vehicle washes (including ‘touchless,’ low pressure, intermediate pressure, high pressure, friction-assisted, and friction washes), apparatus and utensil washes, wheel and rim cleaning washes in automated and/or manual systems, undercarriage washes, special carbon-soil film removal (for vehicles, especially for cars, trucks, motorcycles, trains, and off-road vehicles such as ATV's and snow-mobiles), and rust or stain removal (especially as used in truck washing). The cleaning environment can include outside (unenclosed) wash systems, housed (enclosed) wash units, transient wash systems, or clean-in-place systems. Typically, in transient wash systems vehicles move in assembly-line, conveyed fashion through the system. Typically, in clean-in-place systems the vehicle is placed into a closed environment and the cleaning steps are performed on the vehicle device or apparatus while it is confined and stationary within the environment. In the wash systems (e.g., clean-in-place systems), the various cleaning solutions can be used once before discarding, be partially recycled (mixed with refreshing solution and partially recycled), or be completely recycled, until they are determined to be spent.

The present vehicle care compositions can include, for example, alkyl ether amine, alkyl diamine, or a mixture thereof; propoxylated or mixed alkoxylated quaternary ammonium compound; stabilizer (preferably including neutralizing acid and/or nonionic surfactant); and, typically, water;. Preferred vehicle care compositions according to the present invention include, for example, about 0.1 to about 55 wt-% alkyl ether amine, alkyl diamine, or a mixture thereof; and about 0.1 to about 50 wt-% of a propoxylated or mixed alkoxylated quaternary ammonium compound. Preferably, such compositions include an amount of stabilizer effective for maintaining the composition as a single phase, clear solution.

In an embodiment, the vehicle care compositions of the present invention contain at least an alkyl ether amine, alkyl diamine, or a mixture thereof; propoxylated or mixed alkoxylated quaternary ammonium compound; and stabilizer or solubilizer. These compositions can also include cationic surfactant, solvent, and/or water. The present vehicle care compositions can include, for example: about 0.1 or 1 to about 50 or 55 wt-%, about 0.5 or 2 to about 20 wt-%, preferably about 10 to about 40 wt-%, preferably about 15 to about 25 wt-%, preferably about 20 wt-%, preferably about 2 to about 10 wt-%, preferably about 3 to about 6 wt-%, or preferably about 4 wt-% of alkyl ether amine, alkyl diamine, or a mixture thereof; about 0.1 or 2 to about 50 wt-%, about 0.5 or 1.5 to about 10 wt-%, preferably about 1 to about 4 wt-%, preferably about 2 wt-%, preferably about 0.2 to about 1 wt-%, preferably about 0.5 wt-% propoxylated or mixed alkoxylated quaternary ammonium compound; and 0.01 to about 20 wt-%, about 0.5 or 1 to about 10 or 20 wt-%, about 1.5 to about 15 wt-%, preferably about 3 to about 10 wt-%, preferably about 6 wt-%, preferably about 1 to about 4 wt-%, preferably about 2 wt-%, preferably about 0.2 to about 0.6 wt-%, or preferably about 0.3 wt-% stabilizer. These vehicle care compositions can also include, for example: about 0.01 to about 20 or 40 wt-%, about 0.1 to about 10, 20, 25, or 30 wt-%, about 0.5 or 1 to about 15 or 25 wt-%, preferably about 0.5 to about 2 wt-%, preferably about 1 wt-%, preferably about 1 to about 4 wt-%, preferably about 2 wt-%, preferably about 5 to about 20 wt-%, or preferably about 10 or 12-13 wt-% cationic surfactant; about 1 to about 20 wt-%, about 1.5 to about 10 wt-%, preferably about 1 to about 6 wt-%, or preferably about 3 wt-% solvent; and/or the balance or about 58 to about 68 wt-% water. In certain embodiments, the compositions can include any of these amounts or ranges not modified by about.

In embodiments suitable for drying compositions, the present vehicle care compositions can include, for example: alkyl ether amine, alkyl diamine, or a mixture thereof, preferably alkyl ether amine; propoxylated or mixed alkoxylated quaternary ammonium compound; stabilizer, preferably nonionic surfactant and/or acid. Drying compositions can also include one or more of: cationic surfactant, preferably dimethyl dicoco ammonium chloride and/or amine ethoxylate; solvent; and/or water. Preferred embodiments suitable for drying compositions can include, for example: alkyl C₁₂-C₁₄ oxypropyl diamine alkyl ether amine; poly[oxy(methy-1,2-ethanediyl)], alpha-[2-diethylmethylammonio)ethyl-omega-hydroxy chloride ((C₃H₆O)ₙC₇H₁₈NO.Cl, CAS Number 68132-96-7, sold as GLENSURF™ 42 by Glenn Corporation) as propoxylated or mixed alkoxylated quaternary ammonium compound; plus one or more of: acid (e.g. dicarboxylic acid) as stabilizer; methyl ester as hydrophobe; dimethyl dicoco ammonium chloride and/or amine ethoxylate as cationic surfactant; ethylene glycol monobutyl ether and/or propylene glycol as solvent; and/or water.

In embodiments suitable for drying compositions, the present vehicle care compositions can include, for example: about 1 to about 55 wt-%, about 2 to about 20 wt-%, preferably about 10 to about 40 wt-%, or preferably about 20 wt-% of alkyl ether amine, alkyl diamine, or a mixture thereof; about 2 to about 50 wt-%, about 1.5 to about 10 wt-%, preferably about 1 to about 4 wt-%, preferably about 2 wt-% propoxylated or mixed alkoxylated quaternary ammonium compound; 0.01 to about 20 wt-%, about 0.5 to about 10 wt-%, preferably about 1 to about 4 wt-%, or preferably about 2 wt-% stabilizer; about 0.1 to about 20 or 30 wt-%, about 0.5 to about 15 or 25 wt-%, preferably about 1 to about 4 wt-%, preferably about 2 wt-%, preferably about 5 to about 20 wt-%, or preferably about 10 wt-% cationic surfactant; about 1 to about 20 wt-%, about 1.5 to about 10 wt-%, preferably about 1 to about 6 wt-%, or preferably about 3 wt-% solvent; and/or the balance or about 58 wt-% water. In certain embodiments, the compositions can include any of these amounts or ranges not modified by about.

In embodiments suitable for polishing compositions, the present vehicle care compositions can include, for example: alkyl ether amine, alkyl diamine, or a mixture thereof, preferably alkyl ether amine; propoxylated or mixed alkoxylated quaternary ammonium compound; stabilizer, preferably nonionic surfactant and/or acid. Polishing compositions can also include one or more of cationic surfactant, preferably alkyl dimethyl benzyl ammonium chloride and/or ethoxylated quaternary ammonium compound; solvent; and water. Preferred embodiments suitable for polishing compositions can include, for example: alkyl C₁₂-C₁₄ oxypropyl diamine alkyl ether amine; poly[oxy(methy-1,2-ethanediyl)], alpha-[2-diethylmethylammonio)ethyl-omega-hydroxy chloride ((C₃H₆O)ₙC₇H₁₈NO.Cl, CAS Number 68132-96-7, sold as GLENSURF™ 42 by Glenn Corporation) as propoxylated or mixed alkoxylated quaternary ammonium compound; acid, such as phosphoric acid, and/or nonionic surfactant, such as amine oxide surfactant, as stabilizer; plus one or more of: alkyl dimethyl benzyl ammonium chloride and/or ethoxylated quaternary ammonium compound (e.g., PEG 15 cocomonium chloride) as cationic surfactant; solvent; and/or water.

In embodiments suitable for polishing compositions, the present vehicle care compositions can include, for example: about 0.1 to about 50 wt-%, about 0.5 to about 20 wt-%, preferably about 2 to about 10 wt-%, or preferably about 4 wt-% of alkyl ether amine, alkyl diamine, or a mixture thereof; about 0.1 to about 50 wt-%, about 0.5 to about 10 wt-%, preferably about 0.2 to about 1 wt-%, or preferably about 0.5 wt-% propoxylated or mixed alkoxylated quaternary ammonium compound; about 0.5 or 1 to about 10 or 20 wt-%, about 1.5 to about 15 wt-%, preferably about 3 to about 10 wt-%, preferably about 6 wt-%, preferably about 0.2 to about 0.6 wt-%, or preferably about 0.3 wt-% stabilizer; about 0.01 to about 20 or 40 wt-%, about 0.1 to about 10 or 25 wt-%, about 1 to about 15 wt-%, preferably about 0.5 to about 2 wt-%, preferably about 1 wt-%, preferably about 5 to about 20 wt-%, or preferably about 12-13 wt-% cationic surfactant; about 1 to about 20 wt-%, about 1.5 to about 10 wt-%, preferably about 1 to about 6 wt-%, or preferably about 3 wt-% solvent; and/or the balance or about 68 wt-% water. In certain embodiments, the compositions can include any of these amounts or ranges not modified by about.

Alkyl Ether Amine, Alkyl Diamine, or Mixture Thereof

Alkyl Ether Amine

The vehicle care compositions of the invention can contain an alkyl ether amine compound of the formula:

R₁—O—R₂—NH—A

wherein A is hydrogen or R₃NH₂; R₁ is a C₆-C₂₅ fatty aliphatic group; and R₂ and R₃ are each independently a C₁-C₆ alkylene.

Preferred amines include tetradecyloxypropyl-1,3-diaminopropane; a C₁₂₋₁₄ alkyl oxypropyl-1,3-diaminopropane; a C₁₂₋₁₅ alkyloxypropyl amine; and other similar materials that can be obtained in the market place under the tradenames of TOMAH® DA19, DA17, DA1618, DA14, PA19, PA17, PA16, PA14, PA1214, etc.

Alkyl C₁₂-C₁₄ oxypropyl diamine represents a preferred alkyl ether amine.

Preferably, the alkyl ether amine is present in the composition in an amount from about 0.1 to about 55 wt-%. The present vehicle care compositions can include, for example: about 0.1 or 1 to about 50 or 55 wt-%, about 0.5 or 2 to about 20 wt-%, preferably about 10 to about 40 wt-%, preferably about 15 to about 25 wt-%, preferably about 20 wt-%, preferably about 2 to about 10 wt-%, preferably about 3 to about 6 wt-%, or preferably about 4 wt-% of alkyl ether amine. In embodiments suitable for drying compositions, the present vehicle care compositions can include, for example: about 1 to about 55 wt-%, about 2 to about 20 wt-%, preferably about 10 to about 40 wt-%, or preferably about 20 wt-% of alkyl ether amine. In embodiments suitable for polishing compositions, the present vehicle care compositions can include, for example: about 0.1 to about 50 wt-% or about 0.5 to about 20 wt-%, preferably about 2 to about 10 wt-%, or preferably about 4 wt-% of alkyl ether amine. In certain embodiments, the compositions can include any of these amounts or ranges not modified by about.

Alkyl Diamine

The vehicle care compositions of the invention can contain an alkyl diamine compound of the formula:

RNCH₂CH₂CH₂NH₂

wherein R is C₆-C₂₀ alkyl.

Preferred alkyl diamines include N-octadecenyltrimethylene diamine, N-cocotrimethylene diamine, and other similar materials that can be obtained in the market place under the tradenames of DUOMENE O and DUOMENE CD.

Preferably, the alkyl diamine is present in the composition in an amount from about 0.1 to about 55 wt-%. The present vehicle care compositions can include, for example: about 0.1 or 1 to about 50 or 55 wt-% or about 0.5 or 2 to about 20 wt-% of alkyl diamine. In embodiments suitable for drying compositions, the present vehicle care compositions can include, for example: about 1 to about 55 wt-%, about 2 to about 20 wt-% of alkyl diamine. In embodiments suitable for polishing compositions, the present vehicle care compositions can include, for example: about 0.1 to about 50 wt-%, about 0.5 to about 20 wt-% of alkyl diamine. In certain embodiments, the compositions can include any of these amounts or ranges not modified by about.

Mixtures of Alkyl Ether Amine and Alkyl Diamine

The present vehicle care compositions can include a mixture of alkyl ether amine and alkyl diamine. The present vehicle care compositions can include, for example: about 0.1 or 1 to about 50 or 55 wt-%, about 0.5 or 2 to about 20 wt-%, preferably about 10 to about 40 wt-%, preferably about 15 to about 25 wt-%, preferably about 20 wt-%, preferably about 2 to about 10 wt-%, preferably about 3 to about 6 wt-%, or preferably about 4 wt-% of mixture of alkyl ether amine and alkyl diamine. In embodiments suitable for drying compositions, the present vehicle care compositions can include, for example: about 1 to about 55 wt-%, about 2 to about 20 wt-%, preferably about 10 to about 40 wt-%, or preferably about 20 wt-% of mixture of alkyl ether amine and alkyl diamine. In embodiments suitable for polishing compositions, the present vehicle care compositions can include, for example: about 0.1 to about 50 wt-%, about 0.5 to about 20 wt-%, preferably about 2 to about 10 wt-%, or preferably about 4 wt-% of mixture of alkyl ether amine and alkyl diamine. In certain embodiments, the compositions can include any of these amounts or ranges not modified by about.

Propoxylated or Mixed Alkoxylated Quaternary Ammonium Compound

The propoxylated or mixed alkoxylated quaternary ammonium compound has the formula (II):

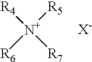

wherein R₄, R₅, R₆, and R₇ are each independently hydrogen, C₁-C₁₀ alkyl, C₁-C₁₀ alkoxy, or phenyl such that at least two of R₄, R₅, R₆, and R₇ are a C₁-C₁₀ alkyl, or at least one of R₄, R₅, R₆, and R₇ are a C₁-C₁₀ alkoxy; and X includes an anion.

In one embodiment, R₄, R₅, and R₆ are each independently C₁-C₆ alkyl groups, and R₇ is a polyoxyalkylene chain of general formula:

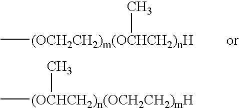

wherein m is from 0 to 30, n is from 1 to 60, and X is an anion. In this embodiment, m plus n can be from 1 to 60 and n can be greater than m. Preferably, the ratio of n/m is at least 2, more preferably n/m is at least 4, even more preferably n/m is at least 5. Moreover, m can be 0. It is also preferred that m plus n is within the range of 5 to 60, still more preferably that m plus n is from about 8 to about 50, and more preferably, m is 0 and n is 35-45.

In an embodiment, R₄ and R₅ are methyl. In this embodiment one of R₆ or R₇ can be phenyl.

The anion, X⁻, can be or include any anion compatible with the composition. Suitable anions include anions of low molecular weight acids, such as chloride, bromide, iodide, sulfate, sulfonate, acetate, nitrate, nitrite, phosphate, and the like.

In a preferred embodiment, the propoxylated or mixed alkoxylated quaternary ammonium compound can be a commercially available propoxylated or mixed alkoxylated quaternary ammonium compound such as, for example, Witco Chemicals Cationic quaternary ammonia compounds Emcol CC-9, Emcol CC-36, and Emcol CC-42. A preferred compound is commercially provided as GLENSURF™ 42, which is inaccurately described as “Diethylammonium Chloride” in a PRODUCT DATA SHEET provided by Glenn Corporation, which sells the product. The CAS Number for the actual compound is 68132-96-7, its Chemical Abstract name of Poly[oxy(methy-1,2-ethanediyl)], alpha-[2-diethylmethylammonio)ethyl-omega-hydroxy chloride, and its chemical formula is listed as (C₃H₆)ₙC₇H₁₈NO.Cl.

In an embodiment, the total number of carbon atoms among R₄, R₅, R₆, and R₇ together number fewer than 12 carbon atoms (with the possible maximum being 12 carbon atoms). In an embodiment, the total number of carbon atoms in the R₄, R₅, and R₆ groups is between 3 and 12 carbon atoms, preferably between 4 and 8 carbon atoms. The most common form of this class of surfactants has as R₄, R₅, and R₆ one methyl radical and two ethyl radicals.

Poly[oxyalkylene] ammonium cationic surfactants are preferred to other cationic surfactants, particularly compared to those quaternary cationic surfactants that make certain components of road soil more persistent on the surface to be cleaned or even attract certain types of soil contaminants. These poly[oxyalkylene] ammonium cationic surfactants (by themselves, but with regard to some of the following characteristics, Suitable poly[oxyalkylene] ammonium cationic surfactants are described in U.S. Pat. Nos. 3,123,640 and 3,141,905 as cation-active surface active chemical compounds. The cation-active compounds are quaternary ammonium compounds derived from lower monoalkyl dialkanolamines. The cations-active compounds also include a) dialiphatic, dialkoxylated quaternary ammonium compounds, and b) monoaliphatic, trialkoxylated quaternary ammonium compounds, as described by formulae in the patents, and are useful in the practice of the invention as the polyoxyalkylene ammonium cationic surfactants. Those patents are incorporated herein by reference for the disclosure of the structure of these classes of compounds.

Preferably, the propoxylated or mixed alkoxylated quaternary ammonium compound is present in the composition in an amount from about 0.1 to about 50 wt-%. The present vehicle care compositions can include, for example: about 0.1 or 2 to about 50 wt-%, about 0.5 or 1.5 to about 10 wt-%, preferably about 1 to about 4 wt-%, preferably about 2 wt-%, preferably about 0.2 to about 1 wt-%, preferably about 0.5 wt-% propoxylated or mixed alkoxylated quaternary ammonium compound. In embodiments suitable for drying compositions, the present vehicle care compositions can include, for example: about 2 to about 50 wt-%, about 1.5 to about 10 wt-%, preferably about 1 to about 4 wt-%, preferably about 2 wt-% propoxylated or mixed alkoxylated quaternary ammonium compound. In embodiments suitable for polishing compositions, the present vehicle care compositions can include, for example: about 0.1 to about 50 wt-%, about 0.5 to about 10 wt-%, preferably about 0.2 to about 1 wt-%, or preferably about 0.5 wt-% propoxylated or mixed alkoxylated quaternary ammonium compound. In certain embodiments, the compositions can include any of these amounts or ranges not modified by about.

Stabilizer/Solubilizer

The vehicle care compositions of the present invention preferably contain a stabilizer or solubilizer to allow the composition to maintain a single phase, clear solution. Preferred solubilizers or stabilizers include acid stabilizer or solubilizer and/or nonionic surfactant. Preferably, the stabilizer is at 0.01 to about 30 wt-%.

The present vehicle care compositions can include, for example: and 0.01 to about 20 wt-%, about 0.5 or 1 to about 10 or 20 wt-%, about 1.5 to about 15 wt-%, preferably about 3 to about 10 wt-%, preferably about 6 wt-%, preferably about 1 to about 4 wt-%, preferably about 2 wt-%, preferably about 0.2 to about 0.6 wt-%, or preferably about 0.3 wt-% stabilizer. In embodiments suitable for drying compositions, the present vehicle care compositions can include, for example: 0.01 to about 20 wt-%, about 0.5 to about 10 wt-%, preferably about 1 to about 4 wt-%, or preferably about 2 wt-% stabilizer. In embodiments suitable for polishing compositions, the present vehicle care compositions can include, for example: about 0.5 or 1 to about 10 or 20 wt-%, about 1.5 to about 15 wt-%, preferably about 3 to about 10 wt-%, preferably about 6 wt-%, preferably about 0.2 to about 0.6 wt-%, or preferably about 0.3 wt-% stabilizer. In certain embodiments, the compositions can include any of these amounts or ranges not modified by about.

Acid Stabilizer/Solubilizer

Any weak acid can be used as a stabilizer or solubilizer. Exemplary weak acids include adipic acid, glutaric acid, succinic acid, acetic acid, hydroxyacetic acid, phosphoric acid, citric acid, and other typical acids used in the manufacture of cleaning, drying, or polishing compositions.

Nonionic Surfactant

Nonionic surfactants useful in drying or polishing compositions, include those having a polyalkylene oxide polymer as a portion of the surfactant molecule. Such nonionic surfactants include, for example, chlorine-, benzyl-, methyl-, ethyl-, propyl-, butyl-, and other like alkyl-capped polyethylene glycol ethers of fatty alcohols; polyalkylene oxide free nonionics such as alkyl polyglycosides; sorbitan and sucrose esters and their ethoxylates; alkoxylated ethylene diamine; alcohol alkoxylates such as alcohol ethoxylate propoxylates, alcohol propoxylates, alcohol propoxylate ethoxylate propoxylates, alcohol ethoxylate butoxylates, and the like; dodecyl, octyl or nonylphenol ethoxylates, polyoxyethylene glycol ethers, and the like; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and polyalkylene oxide block copolymers including an ethylene oxide/propylene oxide block copolymer such as those commercially available under the trademark PLURONIC® (BASF-Wyandotte), and the like; and other like nonionic compounds.

In one embodiment, the nonionic surfactant is an amine oxide. Such materials are made by oxidizing a t-alkyl amine to an amine oxide. Preferred amine oxides are typically C₆₋₂₈ alkyl dimethylamine oxides. Representative examples of such amine oxides are lauryl dimethylamine oxide, dodecyl dimethylamine oxide, tetradecyl dimethylamine oxide, cetyl dimethylamine oxide, stearyl dimethylamine oxide, dodecyl diethylamine oxide, bis(2-hydroxypropyl)tetradecylamine oxide, etc.

Additional Ingredients

Water/Solvents

The formulations of the invention can contain water and/or solvent material. If water is used, any water can be used including, but not limited to, tap water, distilled water, deionized water, service water, soft water, and potable water.

Preferred solvents include alcohols, glycols, glycol ether materials. Such materials typically have aliphatic moieties containing 2 to 6 carbon atoms. Examples of such materials include ethanol, propanol, isopropanol, butanol, 2-butanol, 2-methyl-2-propanol, butoxy diglycol, ethoxy diglycol, polypropylene glycol, ethylene glycol methyl ether, ethylene glycol dimethyl ether, ethylene glycol monobutyl ether, propylene glycol methyl ether, dipropylene glycol n-butyl ether, butoxy ethanol, phenoxy ethanol, methoxy propanol, propylene glycol, n-butyl ether, tripropylene glycol, n-butyl ether, propylene glycol, hexylene glycol, and other similar oxygenated solvents. Preferred solvents include propylene glycol, butyl cellosolve, and ethylene glycol monobutyl ether, particularly for drying compositions. The solvents can function as coupling agents and viscosity control agents.

Preferably solvent is present at 0 to about 20 wt-%. Preferably, water makes up the balance of the composition that is not other ingredients, typically about 40 to about 80 wt-% of the composition. The present vehicle care compositions can include, for example, about 60 to about 70 wt-% water. The present vehicle care compositions can include, for example, about 1 to about 20 wt-%, about 1.5 to about 10 wt-%, preferably about 1 to about 6 wt-%, or preferably about 3 wt-% solvent. In certain embodiments, the compositions can include any of these amounts or ranges not modified by about.

Acid or Base

The compositions of the invention can contain an acidic (stabilizer) or basic material that can act to neutralize either a basic or acidic pH, respectively. The acid/alkaline builder material should be present in amounts sufficient to obtain a pH of about 3 to about 8, preferably 3.5-7.5.

A variety of typically weak or mild acids can be used to neutralize and solubilize the basic compositions to a variety of pHs. Such acids include adipic acid, glutaric acid, succinic acid, acetic acid, hydroxyacetic acid, phosphoric acid, citric acid, and the like.

The base in the composition can be any source of alkalinity known that is compatible with the other components of the composition being used. Suitable alkaline sources or mixtures thereof useful in the present invention are those capable of providing the desired pH. Alkalinity sources can include, for example, inorganic alkalinity sources, such as an alkali metal hydroxide, an alkali metal salt, or the like, or mixtures thereof. Sources of alkalinity include amines, such as ethanolamines, and like alkaline sources.

Suitable alkali metal salts include those generally known that are compatible with the other components of the composition being used. Some examples of alkali metal salts include alkali metal carbonates, silicates, phosphonates, sulfates, borates, acetates, citrates, tartrates, succinates, edates, and the like, and mixtures thereof.

Examples include potassium or sodium carbonates or bicarbonates. Suitable carbonate salts include, for example, potassium carbonate, potassium carbonate dihydrate, potassium carbonate trihydrate, sodium carbonate, sodium carbonate decahydrate, sodium carbonate heptahydrate, sodium carbonate monohydrate, sodium sesquicarbonate, and the double salts, and mixtures thereof Suitable bicarbonate salts include, for example, potassium bicarbonate, sodium bicarbonate, and mixtures thereof.

Other examples include the alkali metal ortho or complex phosphates. Examples of alkali metal orthophosphates include trisodium or tripotassium orthophosphate. Complex phosphates are especially effective because of their ability to chelate water hardness and heavy metal ions. Suitable complex phosphates include, for example, sodium or potassium pyrophosphate, tripolyphosphate, or hexametaphosphate. It is preferred to limit the amount of phosphates to less than 1 wt-% (phosphorus) relative to the total alkaline salts used.

Preferably, the amount of acid or base is in the range of 0 to about 20 wt-%.

Cationic Surfactant

Suitable cationic surfactants include fatty amines (e.g., coco amines, tallow amines, and the like) ethoxylated with, for example, 2 to 18 moles of ethylene oxide. Such ethoxylated fatty amines can be represented by the formula:

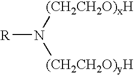

where R is a fatty group, x and y are independently 2-18. Preferably R is a C₁₆₋₁₈ alcohol ethoxylated with 2 to 18 moles of ethylene oxide (EO).

Preferred ethoxylated quaternary ammonium cationic surfactants include a 15 mole ethoxylate of cocomonium chloride of the formula:

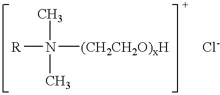

in which R=coco and x+y=15.

Suitable cationic surfactants include dimethyl dicoco ammonium chloride and alkyl dimethyl benzyl ammonium chloride.

Preferred cationic surfactants exclude ethoxylated ether amines.

Preferably, the cationic surfactant is at 0.01 to about 30 wt-%. The present vehicle care compositions can include, for example: about 0.01 to about 20 or 40 wt-%, about 0.1 to about 10, 20, 25, or 30 wt-%, about 0.5 or 1 to about 15 or 25 wt-%, preferably about 0.5 to about 2 wt-%, preferably about 1 wt-%, preferably about 1 to about 4 wt-%, preferably about 2 wt-%, preferably about 5 to about 20 wt-%, or preferably about 10 or 12-13 wt-% cationic surfactant. In embodiments suitable for drying compositions, the present vehicle care compositions can include, for example: about 0.1 to about 20 or 30 wt-%, about 0.5 to about 15 or 25 wt-%, preferably about 1 to about 4 wt-%, preferably about 2 wt-%, preferably about 5 to about 20 wt-%, or preferably about 10 wt-% cationic surfactant. In embodiments suitable for polishing compositions, the present vehicle care compositions can include, for example: about 0.01 to about 20 or 40 wt-%, about 0.1 to about 10 or 25 wt-%, about 1 to about 15 wt-%, preferably about 0.5 to about 2 wt-%, preferably about 1 wt-%, preferably about 5 to about 20 wt-%, or preferably about 12-13 wt-% cationic surfactant. In certain embodiments, the compositions can include any of these amounts or ranges not modified by about.

Hydrophobe

Hydrophobes that can be employed, for example, to increase the rate of water removal from the vehicle. Environmentally acceptable hydrophobes can serve as replacements for hydrocarbons in vehicle care compositions. Suitable hydrophobes include simple esters of natural fatty acids of the formula:

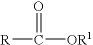

wherein R—C(O) includes approximately 12-26 carbon atoms, and R¹ is from an alcohol moiety having approximately 1-5 carbon atoms. Examples include butyl oleate, methyl cannoleate, methyl laurate, methyl oleate, methyl palmitate, methyl soyate, butyl tallate, methyl tallate, amyl laurate, and the like. The hydrophobe can be present, for example, at 0.01 to about 30 wt-%, preferably about 0.1 to about 15 wt-%, or at either of these ranges or amounts not modified by about.

Other Additives

Other additives can be included in the present compositions. Such additives can include, but are not limited to, additional surfactants, hydrotropes, corrosion inhibitors, antimicrobials, fungicides, fragrances, dyes, antistatic agents, UV absorbers, reducing agents, buffering compounds, corrosion inhibitors, viscosity modifying (thickening or thinning) agents, and the like. Conventional hardening or solidification agents can be used including urea, PEG materials, nonionics, etc. Silicone containing such as the ABIL B8852 or Silwet 7602 can also be used can be employed, for example, in polishing compositions.

Preferred Ranges for the Present Compositions

Compositions according to the present invention can include effective amounts of the ingredients described above. Preferred ranges of amounts of ingredients in the compositions of the present invention include the following.

TABLE 1
Concentrated Vehicle Care Composition

| | Preferred | More Preferred |
|---|---|---|
| Component | Ranges (wt-%) | Ranges (wt-%) |
| Alkyl Ether Amine, Alkyl | 1-55 | 2-20 |
| Diamine, or a mixture | 0.1-50 | |
| thereof | | |
| Propoxylated or Mixed | 2-50 | 1.5-10 |
| Alkoxylated Quaternary | 0.1-50 | 0.1-50 |
| Ammonium Compound | | |
| Stabilizer (e.g., nonionic | 0.01-20 | 0.5-10 |
| surfactant and/or acid) | 0.5-20 | 1-15 |

TABLE 2
Concentrated Drying Composition

| | Preferred | More Preferred |
|---|---|---|
| Component | Range (wt-%) | Range (wt-%) |
| Alkyl Ether Amine, Alkyl | 1-55 | 2-20 |
| Diamine, or a mixture | | |
| thereof | | |
| Propoxylated or Mixed | 2-50 | 1.5-10 |
| Alkoxylated Quaternary | | |
| Ammonium Compound | | |
| Stabilizer (e.g., nonionic | 0.01-20 | 0.5-10 |
| surfactant and/or acid) | | |
| Solvent | 1-20 | 1.5-10 |
| Hydrophobe (e.g., methyl | 0-30 | 0-15 |
| ester) | | |
| Cationic Surfactant (e.g., | 0.1-30 | 0.5-25 |
| dimethyl dicoco | | |
| ammonium chloride | | |
| and/or fatty amine | | |
| ethoxylate) | | |
| Water | Balance | Balance |

In certain embodiments, the composition of Table 2 can include, for example, one or more of the components listed in Table 3.

TABLE 3
Components for Embodiments of Concentrated Drying Composition

| | Preferred | More Preferred |
|---|---|---|
| Component | Range (wt-%) | Range (wt-%) |
| Nonionic Surfactant | 0.01-20 | 0.5-10 |
| Acid | 0.01-15 | 0.5-10 |
| Dimethyl Dicoco | 0.1-30 | 0.5-25 |
| Ammonium Chloride | | |
| Fatty Amine Ethoxylate | 0.1-20 | 0.5-15 |

TABLE 4
Concentrated Polishing Composition

| | | |
|---|---|---|
| | Preferred | More Preferred |
| Component | Range (wt-%) | Range (wt-%) |

| | | |
|---|---|---|
| Alkyl Ether Amine, | 0.1-50 | 0.5-20 |
| Propoxylated or Mixed | 0.1-50 | 0.5-10 |
| Alkoxylated Quaternary | | |
| Ammonium Compound | | |
| Stabilizer (e.g., nonionic | 0.5-20 | 1-15 |
| surfactant and/or acid) | | |
| Cationic Surfactant (e.g., | 0-40 | 0.1-25 |
| alkyl dimethyl benzyl | | |
| ammonium chloride | | |
| and/or fatty ethoxylated | | |
| quaternary ammonium | | |
| compound) | | |
| Silicone Surfactant | 0-15 | 0.5-10 |
| Water | Balance | Balance |

The concentrated polishing composition of Table 4 can be formulated according to, for example, Table 5.

TABLE 5
Concentrated Polishing Composition

| | Preferred | More Preferred |
|---|---|---|
| Component | Range (wt-%) | Range (wt-%) |
| Alkyl Ether Amine, | 0.1-50 | 0.5-20 |
| Alkyl Diamine, or a | | |
| mixture thereof | | |
| Propoxylated or Mixed | 0.1-50 | 0.5-10 |
| Alkoxylated Quaternary | | |
| Ammonium Compound | | |
| Nonionic Surfactant | 1-20 | 1.5-15 |
| Acid | 0.5-20 | 1-15 |
| Silicone Surfactant | 0-15 | 0.5-10 |
| Alkyl Dimethyl Benzyl | 0-20 | 1-15 |
| Ammonium Chloride | | |
| Fatty Ethoxylated | 0.01-20 | 0.1-10 |
| Quaternary Ammonium | | |
| Compound | | |
| Water | Balance | Balance |

Examples of preferred amounts of ingredients for the present use compositions can be found in Tables 6-10.

TABLE 6
Use Vehicle Care Composition

| | Preferred | More Preferred |
|---|---|---|
| Component | Range (ppm) | Range (ppm) |
| Alkyl Ether Amine, Alkyl | 2-1100 | 4-400 |
| Diamine, or a mixture | 5-5000 | 25-2000 |
| thereof | | |
| Propoxylated or Mixed | 2-400 | 3-200 |
| Alkoxylated Quaternary | 5-5000 | 25-1000 |
| Ammonium Compound | | |
| Stabilizer (e.g., nonionic | 0.5-400 | 1-200 |
| surfactant and/or acid) | 25-5500 | 50-4000 |

TABLE 7
Use Drying Composition

| | Preferred | More Preferred |
|---|---|---|
| Component | Range (ppm) | Range (ppm) |
| Alkyl Ether Amine, Alkyl | 2-1100 | 4-400 |
| Diamine, or a mixture | | |
| thereof | | |
| Propoxylated or Mixed | 2-400 | 3-200 |
| Alkoxylated Quaternary | | |
| Ammonium Compound | | |
| Stabilizer (e.g., nonionic | 0.5-400 | 1-200 |
| surfactant and/or acid) | | |
| Solvent | 2-400 | 3-200 |
| Hydrophobe (e.g., methyl | 0-600 | 0-300 |
| ester) | | |
| Cationic Surfactant (e.g., | 2-1000 | 2.5-400 |
| dimethyl dicoco | | |
| ammonium chloride | | |
| and/or fatty amine | | |
| ethoxylate) | | |
| Water | Balance | Balance |

In certain embodiments, the composition of Table 7 can include, for example, one or more of the components listed in Table 8.

TABLE 8
Components for Embodiments of Use Drying Composition

| | Preferred | More Preferred |
|---|---|---|
| Component | Range (ppm) | Range (ppm) |
| Nonionic Surfactant | 0.5-400 | 1-200 |
| Acid | 0.5-300 | 1-200 |
| Dimethyl Dicoco | 2-600 | 2.5-200 |
| Ammonium Chloride | | |
| Fatty Amine Ethoxylate | 2-400 | 3-200 |

TABLE 9
Use Polishing Composition

| | Preferred | More Preferred |
|---|---|---|
| Component | Range (ppm) | Range (ppm) |
| Alkyl Ether Amine, | 5-5000 | 25-2000 |
| Alkyl Diamine, or a | | |
| mixture thereof | | |
| Propoxylated or Mixed | 5-5000 | 25-2000 |
| Alkoxylated Quaternary | | |
| Ammonium Compound | | |
| Stabilizer (e.g., nonionic | 25-5500 | 50-4000 |
| surfactant and/or acid) | | |
| Silicone Surfactant | 0-1500 | 50-1000 |
| Cationic Surfactant (e.g., | 0-5500 | 15-3000 |
| alkyl dimethyl benzyl | | |
| ammonium chloride | | |
| and/or fatty ethoxylated | | |
| quaternary ammonium | | |
| compound) | | |
| Water | Balance | Balance |

The use polishing composition of Table 9 can be formulated according to, for example, Table 10.

TABLE 10
Use Polishing Composition

| | Preferred | More Preferred |
|---|---|---|
| Component | Range (ppm) | Range (ppm) |
| Alkyl Ether Amine, | 5-5000 | 25-2000 |
| Alkyl Diamine, or a | | |
| mixture thereof | | |
| Propoxylated or Mixed | 5-5000 | 25-1000 |
| Alkoxylated Quaternary | | |
| Ammonium Compound | | |
| Nonionic Surfactant | 50-2000 | 75-1500 |
| Acid | 25-2000 | 50-1500 |
| Silicone Surfactant | 0-1500 | 50-1000 |
| Alkyl Dimethyl Benzyl | 0-2000 | 50-1500 |
| Ammonium Chloride | | |
| Fatty Ethoxylated | 2.5-3500 | 15-1500 |
| Quaternary Ammonium | | |
| Compound | | |
| Water | Balance | Balance |

The present invention may be better understood with reference to the following example. This example is intended to be representative of specific embodiments of the invention, and is not intended as limiting the scope of the invention.

### EXAMPLE

The following compositions have been formulated as an example of an embodiment of a polish composition and an example of an embodiment of a drying composition.

TABLE 11
Embodiments of Compositions for Drying Agent and Polish

| DRYING AGENT | |
|---|---|
| 20.0 | Alkyl Ether Amine (e.g., |
| | alkyl C₁₂-C₁₄ oxypropyl |
| | diamine) |
| 2.0 | Propoxylated or Mixed |
| | Alkoxylated Quaternary |
| | Ammonium Compound¹ |
| 3.0 | Dicarboxylic Acid(s) |
| 2.0 | Tallow Amine Ethoxylate |
| | (5) |
| 10.0 | Dicoco Dimethyl |
| | Ammonium Chloride |
| | (75%) |
| 2.0 | Ethylene Glycol |
| | Monobutyl Ether |
| 3.0 | Propylene Glycol |
| 58.0 | D.I. Water |
| 4.0 | Alkyl Ether Amine (e.g., |
| | alkyl C₁₂-C₁₄ oxypropyl |
| | diamine) |
| 0.5% | Propoxylated or Mixed |
| | Alkoxylated Quaternary |
| | Ammonium Compound¹ |
| 6.0% | Lauryl Dimethylamine |
| | Oxide 30% |
| 8.0 | 75% Phosphoric Acid |
| 12.5% | Alkyl Dimethyl Benzyl |
| | Ammonium Chloride |
| | (50%) |
| 1.0% | PEG 15 Cocmonium |
| | Chloride (75%) |
| 0.3 | Siloxane Blend |
| 67.7 | Soft water |
| ¹The propoxylated or mixed alkoxylated quaternary ammonium compound employed in this composition is commercially available as GLENSURF ™ 42, which is inaccurately described as “Diethylammonium Chloride” in a PRODUCT DATA SHEET provided by Glenn Corporation, which sells the product. The CAS Number for the actual compound is 68132-96-7, its Chemical Abstract name of Poly[oxy(methy-1,2-ethanediyl)], alpha-[2-diethylmethylammonio)ethyl-omega- | |
| #hydroxy chloride, and its chemical formula is listed as (C₃H₆O)ₙC₇H₁₈NO.Cl. | |

The data presented in the following table demonstrate the superior drying characteristics of the vehicle care compositions of the present invention, particularly the drying agent and polish described in Table 11.

Test Procedure

1. Clean the inside of the stainless steel container with 5% detergent solution. Rinse with water until no sign of foam. Dry outside of container with paper towel.

2. Place container on balance and tare to zero. Add 1999 grams of tap water at 75-80° F. Add 1 gram of drying agent or 13.3 grams of polish in 1986.7 grams of tap water and mix for 10 seconds.

3. Invert container (pour out) and let drain for 10 seconds. Tare balance to zero and record weight of beaker and water remaining. This is the weight after the first draining.

4. Subtract the dry weight from the second value.

5. Tare container and add 2000 grams of 75-80° F. water.

6. Invert container (pour out) and let drain for 10 seconds. Tare balance to zero and record weight and record weight. This is the weight after the second draining.

7. Subtract the dry weight from the value recorded.

Water Removal From a Surface Without Use of a Hydrocarbon

| | | | A | | | | |
|---|---|---|---|---|---|---|---|
| | | | (First Draining) | | | D | |
| | | | Weight of | B | C | (Second Draining) | E |
| | | | container plus | Container | (First Draining) | Weight of | (Second Draining) |
| | | | product after | tare | Wt change after | container plus | Wt change after |
| | | | draining for 10 | (empty) wt. | first draining for | water after | second draining for |
| water temp 75-80 F. | Product | Test | sec. (grams) | in grams | 10 sec. (grams) | draining for 10 sec | 10 sec. (grams) |
| 1 g of product and | Drying Agent of Table | 1 | 578.76 | 578.5 | 0.26 | 579.06 | 0.56 |
| 1999 g water | 11 | 2 | 579.26 | 578.5 | 0.76 | 579.05 | 0.55 |
| | | 3 | 579.58 | 578.5 | 1.08 | 579.01 | 0.51 |
| | | 4 | 579.1 | 578.5 | 0.6 | 578.96 | 0.46 |
| | | 5 | 579.17 | 578.5 | 0.67 | 579.7 | 1.2 |
| | | | 579.1 | 578.5 | 0.6 | 579.58 | 1.08 |
| | | | | | 0.662 | average | 0.727 |
| | Control water only | | 580.13 | 578.5 | 1.63 | 580.2 | 1.7 |
| 1 g of product and | Conventional | 1 | 579.85 | 578.5 | 1.35 | 579.56 | 1.06 |
| 1999 g water | Hydrocarbon Containing | 2 | 578.85 | 578.5 | 0.35 | 579.17 | 0.67 |
| | Drying agent | 3 | 578.96 | 578.5 | 0.46 | 579.43 | 0.93 |
| | | 4 | 579.12 | 578.5 | 0.62 | 579.5 | 1 |
| | | | 579.17 | 578.5 | 0.67 | 579.58 | 1.08 |
| | | | | | 0.69 | average | 0.948 |
| | Control water only | | 580.05 | 578.5 | 1.55 | 580.04 | 1.54 |
| 13.3 g of product and | Polish of Table 11 | 1 | 580.59 | 578.5 | 2.09 | 579.31 | 0.81 |
| 1986.7 g water | | 2 | 580.83 | 578.5 | 2.33 | 579.45 | 0.95 |
| | | 3 | 581.17 | 578.5 | 2.67 | 579.57 | 1.07 |
| | | 4 | 580.66 | 578.5 | 2.16 | 579.37 | 0.87 |
| | | 5 | 580.63 | 578.5 | 2.13 | 579.54 | 1.04 |
| | | | | | 2.276 | average | 0.948 |
| | Control water only | | 580.25 | 578.5 | 1.75 | 580.12 | 1.62 |
| 13.3 g of product and | Conventional | 1 | 578.99 | 578.5 | 0.49 | 579.13 | 0.63 |
| 1986.7 g water | Hydrocarbon Containing | 2 | 579.06 | 578.5 | 0.56 | 579.23 | 0.73 |
| | Polish | 3 | 579.28 | 578.5 | 0.78 | 579.32 | 0.82 |
| | | 4 | 579.24 | 578.5 | 0.74 | 579.13 | 0.63 |
| | | 5 | 579.1 | 578.5 | 0.6 | 579.37 | 0.87 |
| | | | | | 0.634 | average | 0.736 |
| | Control - water only | | 580.1 | 578.5 | 1.6 | 579.99 | 1.49 |
| | Control - water only | | 580.32 | 578.5 | 1.82 | 579.89 | 1.39 |

```
Formulation of conventional hydrocarbon containing drying agent:
30.0% Mineral Seal Oil (hydrocarbon)
12.0% Dicoco Dimethyl Ammonium Chloride (75%)
  2.5% Nonylphenol 9.5 mole Ethoxylate
  6.0% Solvent
49.5% Soft Water
Formulation of conventional hydrocarbon containing polish:
  9.0% Cationic Surfactant
  4.0% Alkyl Dimethyl Benzyl Ammonium Chloride (50%)
  2.0% Amine Ethoxylate
  8.0% Mineral Seal Oil (hydrocarbon)
  2.0% Solvent
75.0% Soft Water
```

While the present invention is described in combination with a particular sequence in certain of the methods, the various configurations can be designed within the spirit and scope of this invention to accomplish the methods. Further, the steps of the present methods can be performed in any order including simultaneously, unless performance of a step requires a product of a previous step.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

What is claimed is:

1. A vehicle care composition comprising:
(a) about 0.1 to about 55 wt-% of:
an alkyl ether amine composition of the formula (Ia)
^{R}^{₁}^{—O—R}^{₂}^{—NH—A} (Ib)
wherein A is hydrogen or R₃NH₂,
R₁ is a C₆-C₂₈ fatty aliphatic group, and
R₂ and R₃ are each independently a C₁-C₈ alkylene or a linear or branched alkyl group;
an alkyl diamine compound of formula (Ib):
RNCH₂CH₂CH₂NH₂ (Ib)
wherein R is C₆-C₂₀ alkyl; or
a mixture thereof;
(b) about 0.1 to about 50 wt-% of propoxylated or mixed alkoxylated quaternary ammonium compound of the formula (II) 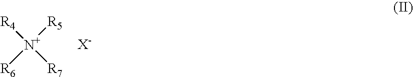
wherein R₄, R₅, R₆, and R₇ are each independently hydrogen, C₁-C₁₉ alkyl, C₁-C₁₀ alkoxy, or phenyl,
such that at least two of R₄, R₅, R₆, and R₇ are a C₁-C₁₀ alkyl, or at least one of R₄, R₅, R₆, and R₇ are a C₁-C₁₀ alkoxy; and
X comprises an anion;
(c) a stabilizer comprising a neutralizing acid, a nonionic surfactant, or a combination thereof; and
(d) water.

2. The composition of claim 1, wherein the alkyl ether amine comprises C₁₀-C₂₀ alkyl oxyalkyl-1,3-diaminopropane, C₁₀-C₂₀ alkyl oxyalkylamine or mixtures thereof.

3. The composition of claim 1, wherein the alkyl ether amine comprises alkyl C₁₂-C₁₄ oxypropyl diamine.

4. The composition of claim 1, wherein the propoxylated or mixed alkoxylated quaternary ammonium compound comprises poly[oxy(methy-1,2-ethanediyl)], alpha-[2-diethylmethylammonio)ethyl-omega-hydroxy chloride.

5. The composition of claim 1, wherein the stabilizer comprises nonionic surfactant.

6. The composition of claim 1, wherein the nonionic surfactant comprises a C₆-C₂₄ alcohol ethoxylate, an alkylphenol ethoxylate, EO/PO block copolymer, a linear alcohol ethoxylate, amine oxide, or mixtures thereof.

7. The composition of claim 1, comprising:
about 0.1 to about 55 wt-% of alkyl ether amine,
about 0.1 to about 50 wt-% of propoxylated or mixed alkoxylated quaternary ammonium compound,
about 0.1 to about 20 wt-% nonionic surfactant, and
water; and
further comprising 0.1 to about 15 wt-% of acid or base effective to obtain a substantially neutral pH.

8. The composition of claim 1, comprising:
about 0.1 to about 50 wt-% of alkyl ether amine,
about 0.1 to about 50 wt-% of propoxylated or mixed alkoxylated quaternary ammonium compound,
about 1 to about 20 wt-% of nonionic surfactant, and
water; and
further comprising about 0.5 to about 20 wt-% of acid effective to obtain a substantially acidic pH.

9. The composition of claim 1, comprising:
about 2 to about 1100 ppm of alkyl ether amine,
about 2 to about 400 ppm of propoxylated or mixed alkoxylated quaternary ammonium compound,
about 0.1 to about 400 ppm of nonionic surfactant, and
water; and
further comprising about 0.1 to about 300 ppm of acid effective to obtain a slightly acidic pH.

10. The composition of claim 1, comprising:
about 5 to about 5000 ppm of alkyl ether amine,
about 5 to about 5000 ppm of propoxylated or mixed alkoxylated quaternary ammonium compound,
about 50 to about 2000 ppm of nonionic surfactant, and
water; and
further comprising about 25 to about 2000 ppm of acid or base effective to obtain a substantially neutral pH.

11. The composition of claim 1, formulated as foam, liquid concentrate, or solid concentrate.

12. The composition of claim 1, further comprising an ethoxylate amine of the formula R—N(A)(B) where
A is (EO)ₓ;
B is (EO)_{y} or H;
EO is ethylene oxide;
x is a number from about 1 to 50; and
R is a fatty alkyl group.

13. A method of cleaning a vehicle surface comprising:
contacting a soiled vehicle surface with a composition comprising:
(a) about 0.1 to about 55 wt-% of:
an alkyl ether amine composition of the formula (Ia)
^{R}^{₁}^{—O—R}^{₂}^{—NH—A} (Ia)
wherein A is hydrogen or R₃NH₂,
R₁ is a C₆-C₂₈ fatty aliphatic group, and
R₂ and R₃ are each independently a C₁-C₈ alkylene or a linear or branched alkyl;
an alkyl diamine compound of formula (Ib):
RNCH₂CH₂CH₂NH₂ (Ib)
wherein R is C₆-C₂₀ alkyl; or
a mixture thereof;
(b) about 0.1 to about 50 wt-% of propoxylated or mixed alkoxylated quaternary ammonium compound of the formula (II) 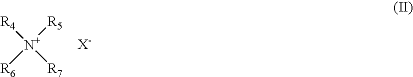
wherein R₄, R₅, R₆, and R₇ are each independently hydrogen, C₁-C₁₀ alkyl, or C₁-C₁₀ alkoxy,
such that at least two of R₄, R₅, R₆, and R₇ are a C₁-C₁₀ alkyl, or at least one of R₄, R₅, R₆, and R₇ are a C₁-C₁₀ alkoxy; and
X comprises an anion;
(c) a stabilizer comprising neutralizing acid, nonionic surfactant, or a combination thereof; and
(d) water; and
rinsing the vehicle surface to wash away the composition and the soil.

14. The method of claim 13, wherein the alkyl ether amine comprises alkyl C₁₂-C₁₄ oxypropyl diamine.

15. The method of claim 13, wherein the propoxylated or mixed alkoxylated quaternary ammonium compound comprises poly[oxy(methy-1,2-ethanediyl)], alpha-[2-diethylmethylammonio)ethyl-omega-hydroxy chloride.

16. The method of claim 13, wherein rinsing comprising rinsing with low or high pressure water.

17. A method of dewatering a vehicle surface comprising:
applying to a substantially clean vehicle surface a drying composition comprising:
(a) about 0.1 to about 55 wt-% of an alkyl ether amine composition of the formula (Ia)
^{R}^{₁}^{—O—R}^{₂}^{—NH—A} (Ia)
wherein A is hydrogen or R₃NH₂,
R₁ is a C₆-C₂₈ fatty aliphatic group, and
R₂ and R₃ are each independently a C₁-C₈ alkylene or a linear or branched alkyl;
(b) about 0.1 to about 50 wt-% of propoxylated or mixed alkoxylated quaternary ammonium compound of the formula (II) 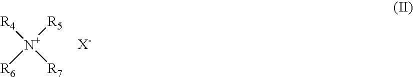
wherein R₄, R₅, R₆, and R₇ are each independently hydrogen, C₁-C₁₀ alkyl, or C₁-C₁₀ alkoxy,
such that at least two of R₄, R₅, R₆, and R₇ are a C₁-C₁₀ alkyl, or at least one of R₄, R₅, R₆, and R₇ are a C₁-C₁₀ alkoxy; and
X comprises an anion;
(c) a stabilizer comprising neutralizing acid, nonionic surfactant, or a combination thereof; and
(d) water; and
draining or blowing the aqueous composition from the vehicle surface.

18. The method of claim 17, wherein the alkyl ether amine comprises alkyl C₁₂-C₁₄ oxypropyl diamine.

19. The method of claim 17, wherein the propoxylated or mixed alkoxylated quaternary ammonium compound comprises poly[oxy(methy-1,2-ethanediyl)], alpha-[2-diethylmethylammonio)ethyl-omega-hydroxy chloride.

20. A method of polishing a vehicle surface comprising:
applying to a vehicle surface a polishing composition comprising:
(a) about 0.1 to about 55 wt-% of an alkyl ether amine composition of the formula (Ia)
^{R}^{₁}^{—O—R}^{₂}^{—NH—A} (Ia)
wherein A is hydrogen or R₃NH₂,
R₁ is a C₆-C₂₈ fatty aliphatic group, and
R₂ and R₃ are each independently a C₁-C₆ alkylene;
an alkyl diamine compound of formula (Ib):
RNCH₂CH₂CH₂NH₂ (Ib)
wherein R is C₆-C₂₀ alkyl; or
a mixture thereof;
(b) about 0.1 to about 50 wt-% of propoxylated or mixed alkoxylated quaternary ammonium compound of the formula (II) 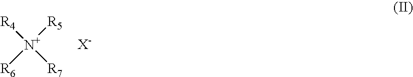
wherein R₄, R₅, R₆, and R₇ are each independently hydrogen, C₁-C₁₀ alkyl, or C₁-C₁₀ alkoxy,
such that at least two of R₄, R₅, R₆, and R₇ are a C₁-C₁₀ alkyl, or at least one of R₄, R₅, R₆, and R₇ are a C₁-C₁₀ alkoxy; and
X comprises an anion;
(c) a stabilizer comprising acid, nonionic surfactant, or a combination thereof; and
(d) water; and
removing the polishing composition from the vehicle surface.

21. The method of claim 20, further comprising subjecting the vehicle surface and the polishing composition to a mechanical action.

22. The method of claim 20, wherein the alkyl ether amine comprises alkyl C₁₂-C₁₄ oxypropyl diamine.

23. The method of claim 20, wherein the propoxylated or mixed alkoxylated quaternary ammonium compound comprises poly[oxy(methy-1,2-ethanediyl)], alpha-[2-diethylmethylammonio)ethyl-omega-hydroxy chloride.
